(19) United States
(12) Patent Application Publication
(10) Pub. No.: US 2020/0208570 A1
(43) Pub. Date: Jul. 2, 2020

(54) COMPRESSOR FOR A CHARGING DEVICE OF AN INTERNAL COMBUSTION ENGINE, AND CHARGING DEVICE FOR AN INTERNAL COMBUSTION ENGINE

(71) Applicant: Vitesco Technologies GMBH, Hannover (DE)

(72) Inventors: Mathias Bogner, Straubing (DE); Christoph Schäfer, Coburg (DE); Sasa Slavic, Heidelberg (DE)

(73) Assignee: Vitesco Technologies GMBH, Hannover (DE)

(21) Appl. No.: 16/818,429

(22) Filed: Mar. 13, 2020

Related U.S. Application Data
(63) Continuation of application No. PCT/EP2018/070122, filed on Jul. 25, 2018.

(30) Foreign Application Priority Data
Sep. 14, 2017 (DE) 10 2017 216 323.2

(51) Int. Cl. F02B 37/22; F02B 39/10; F02B 39/04; F04D 29/42; F04D 29/28; F04D 29/043; F04D 29/08; F04D 29/046; F04D 29/46; F04D 17/10; F16K 3/03

(52) U.S. Cl. CPC F02B 37/225; F02B 39/10; F02B 39/04; F04D 29/4206; F04D 29/284; F16K 3/03; F04D 29/083; F04D 29/046; F04D 29/462; F04D 17/10; F04D 29/043

(57) ABSTRACT

A compressor for a charging device of an internal combustion engine has a compressor impeller arranged for conjoint rotation on a rotor shaft. An air supply channel conducts an air mass flow to the compressor impeller. An iris diaphragm mechanism is upstream of the compressor impeller and has multiple lamellae to close or to open a diaphragm aperture to vary a flow cross section for the air mass flow for flow against the compressor impeller. A housing at least partially delimits the air supply channel. The iris diaphragm mechanism is located in the housing. An actuator is mechanically coupled to the iris diaphragm mechanism via an opening in the housing for the purpose of actuating the iris diaphragm mechanism, wherein the actuator is arranged on the housing such that the opening is closed off by the actuator.

### CROSS REFERENCE TO RELATED APPLICATIONS

This application claims the benefit of PCT Application PCT/EP2018/070122, filed Jul. 25, 2018, which claims priority to German Application DE 10 2017 216 323.2 filed Sep. 14, 2017. The disclosures of the above applications are incorporated herein by reference.

### TECHNICAL FIELD

The invention relates to a compressor for a charging device of an internal combustion engine and to a charging device for an internal combustion engine.

### BACKGROUND

Charging devices such as exhaust-gas turbochargers are increasingly being used to increase power in motor vehicle internal combustion engines. More and more frequently, this is done with the aim of reducing the overall size and weight of the internal combustion engine for the same power or even increased power and, at the same time, of reducing consumption and thus CO₂ emissions, with regard to ever stricter legal requirements in this respect. Energy contained in the exhaust-gas flow is used to increase a pressure in an intake tract of the internal combustion engine and thus to bring about better filling of a combustion chamber of the internal combustion engine with atmospheric oxygen. In this way, more fuel, such as gasoline or diesel, can be converted in each combustion process, i.e. the power of the internal combustion engine can be increased.

An exhaust-gas turbocharger has an exhaust-gas turbine arranged in the exhaust tract of the internal combustion engine, a fresh-air compressor arranged in the intake tract and a rotor bearing arranged therebetween. The exhaust-gas turbine has a turbine housing and a turbine impeller arranged therein, which is driven by the exhaust-gas mass flow. The fresh-air compressor has a compressor housing and a compressor impeller arranged therein, which builds up a boost pressure. The turbine impeller and the compressor impeller are arranged for conjoint rotation on the opposite ends of a common shaft, referred to as the rotor shaft, and thus form what is referred to as the turbocharger rotor. The rotor shaft extends axially between the turbine impeller and compressor impeller through the rotor bearing arranged between the exhaust-gas turbine and fresh-air compressor, and is rotatably mounted in said rotor bearing in the radial and axial directions in relation to the rotor shaft axis. According to this construction, the turbine impeller driven by the exhaust-gas mass flow drives the compressor impeller via the rotor shaft, thereby increasing the pressure in the intake tract of the internal combustion engine, behind the fresh-air compressor in relation to the fresh-air mass flow, and thereby ensuring better filling of the combustion chamber with atmospheric oxygen.

In terms of its operating behavior, the compressor is characterized by a so-called compressor characteristic map, which describes the pressure build-up versus the mass throughput for different compressor rotational speeds or circumferential speeds. A stable and usable characteristic map of the compressor is bounded toward low throughputs by the so-called surge limit, toward relatively high throughputs by the so-called choke limit, and in terms of structural mechanics by the maximum rotational speed limit.

In adapting a charging device such as an exhaust-gas turbocharger to an internal combustion engine, a compressor is selected which has a compressor characteristic map which is as expedient as possible for the internal combustion engine. The following preconditions should be satisfied here: an engine full-load curve is to be completely within the usable compressor characteristic map; minimum clearances with respect to the characteristic map limits, as required by the vehicle manufacturer, are to be maintained; maximum compressor efficiencies are to be available at the rated load and in a range of a low-end apex torque of the internal combustion engine; and the compressor impeller is to have a minimum moment of inertia.

Simultaneous satisfaction of all the preconditions mentioned would be possible only to a limited extent with a conventional compressor without additional measures. For example, the following conflicting aims would arise from opposing trends: reduction in the moment of inertia of the compressor and maximization of the characteristic map width and of the peak efficiency, reduction of scavenging in the region of the low-end apex torque and maximization of the specific rated power, improvement of the response and increase in the specific rated power of the internal combustion engine.

The stated conflicting aims could be resolved by a compressor design which has a wide characteristic map with a minimum moment of inertia and maximum efficiencies on the full-load curve of the engine.

Apart from the steady-state requirements mentioned, stable operating behavior of the compressor must also be ensured in transient operating states, for example in the case of rapid load shedding by the internal combustion engine. This means that the compressor must also not enter the state of so-called surging if the conveyed compressor mass flow is suddenly reduced.

While being restricted to the compressor inlet of an exhaust-gas turbocharger, the aforementioned solution has hitherto been achieved by additional measures, such as adjustable inlet guide vanes, measures for reducing an inlet cross section of the compressor or a fixed recirculation channel, also referred to as a ported shroud or characteristic map-stabilizing measure. In the case of the variable solutions, the widening of the useful working range of the compressor is achieved through active shifting of the characteristic map. In this regard, during engine operation at low rotational speeds and throughputs, the compressor characteristic map is shifted to the left toward low mass flows, while, during engine operation at high rotational speeds and throughputs, the compressor characteristic map is not shifted or is shifted to the right.

Through the setting of vane angles and the induction of a pre-swirl in or counter to the direction of rotation of the compressor impeller, shifting of the entire compressor characteristic map toward relatively low or relatively high throughputs is realized by the inlet guide vanes. However, the adjusting mechanism of the inlet guide vanes constitutes a complicated solution.

Shifting of the compressor characteristic map toward relatively low throughputs is realized by the measures involving narrowing of the compressor inlet by cross-section reduction, in that the inlet cross section is reduced by closing the structure immediately in front of the compressor. In the open state, exposure of the entire inlet cross section again is realized as far as possible by the measures and, in this way, influencing or shifting of the characteristic map is realized either not at all or only marginally by said measures.

The fixed recirculation channel is a passive solution. It extends the useful characteristic map range of the compressor without fundamentally causing the characteristic map thereof to shift. In relation to the inlet guide vanes and the variable cross-section reduction described, it constitutes a significantly more expedient but, at the same time, less efficient solution.

For the purpose of avoid surging in the case of rapid load shedding, a so-called “blow-off” valve is usually used, said valve, in the case of a sudden decrease in the mass flow of charge air through the engine, opening a bypass from the compressor outlet to the compressor inlet and in this way keeping the compressor in the stable characteristic map range to the right of the surge limit. A combination of active measures, such as variable inlet guide vanes and the overrun air recirculation valve, is conceivable but unusual.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A compressor, for example a radial compressor, for a charging device of an internal combustion engine is disclosed. The compressor has a compressor impeller which is arranged for conjoint rotation on a rotor shaft. The compressor has an air supply channel for conducting an air mass flow to the compressor impeller. Further, provision is made of an iris diaphragm mechanism which is arranged upstream of the compressor impeller and which has multiple lamellae and is designed to close or open a diaphragm aperture, such that variable setting of a flow cross section for the air mass flow, for flow against the compressor impeller, is possible. The compressor has a housing which at least partially delimits the air supply channel and in which the iris diaphragm mechanism is arranged and mounted. Further, provision is made of an actuator which, via an opening in the housing, is mechanically coupled to the iris diaphragm mechanism for the purpose of actuating the latter. The actuator is arranged on the housing such that the opening is closed off in a sealed-off manner by means of the actuator.

The compressor for the charging device provides a variable iris diaphragm mechanism which is typically arranged directly in front of the compressor inlet for shifting of the characteristic map. The iris diaphragm mechanism may also be referred to as iris diaphragm or iris throttle and has the task of setting the inlet mass flow of the compressor by way of stepless variation of the flow cross section. In this case, the iris throttle acts like a kind of mask for an outer region of the compressor inlet. With increasing throttling, i.e. cross-sectional narrowing, the iris throttle performs the function of an overrun air recirculation valve at the same time, since it can prevent surging of the compressor. This makes it possible to actively influence the operating range of the compressor and, in addition, to keep the compressor at a stable operating point in the event of sudden load shedding by the engine.

The iris diaphragm mechanism has multiple lamellae which are able to be displaced one inside the other by rotation. The iris diaphragm mechanism is mounted in the above-mentioned (fixed) housing. Each lamella is mounted not only in or on the fixed housing but also on a movably mounted adjusting ring. The housing is for example a separate housing of the iris diaphragm mechanism, part of the compressor housing of the charging device, or of multi-part form, for example by a part of the compressor housing and a separate, additional housing part. The housing is for example of ring-shaped form or has a ring-shaped portion. The housing may also be a fixed, ring-shaped housing element. The lamellae are synchronized and moved jointly via the adjusting ring. Rotation of the adjusting ring also triggers rotation of the lamellae. When the lamellae are rotated parallel to the axis of rotation of the compressor impeller, the lamellae pivot radially inward and thus cause a desired narrowing of the flow cross section directly in front of the compressor impeller. The adjusting ring itself is actuated and moved via the actuator. The actuator is for example an electrically or pneumatically operated control element.

A lamella has a substantially plate-like and/or planar lamella main body, which serves for the screening of the air mass flow and thus for the setting of the diaphragm aperture. For the mounting on the housing and adjusting ring, a lamella has for example two holding elements (also actuation elements), which, for example, are each arranged in a fastening portion of the lamella main body. A holding element is for example in the form of a holding pin or pin-like holding body. A holding element typically extends normal to a main plane of extent of the lamella main body. The fastening portions may be formed for example as a first and second end or as a first and second end region of the respective lamella. The two fastening portions of a lamella typically have identical wall thicknesses.

The air supply channel is formed in the compressor. For example, the air supply channel is formed at least partially by the housing, the iris diaphragm mechanism, an intake connector and/or other components of the compressor.

In the case of the compressor described, the actuator itself acts as part of a seal. In other words, a seal integrated into the actuator is provided. In this way, the flow space, for example the air supply channel and the space within the housing in which the iris diaphragm mechanism is mounted, is sealed off with respect to surroundings of the compressor. In this way, leakage flows from within the compressor outward to the surroundings cannot occur. The actuator and the housing, as a mating part, are consequently connected to one another in a sealing manner. The housing surrounds at least one adjusting ring and the lamellae of the iris diaphragm mechanism.

The actuator seals off with respect to the housing such that the sealing is achieved between two parts which are not moved during operation. Further, the elements of the iris diaphragm mechanism, in particular the lamellae and the adjusting ring, can move freely within the housing. Adjustment forces for setting the diaphragm aperture are consequently significantly smaller in comparison with an embodiment in which the moved parts would be sealed off, since, in this case, owing to the contact between sealing surfaces and sliding surfaces, additional friction would be generated.

Lubrication of the encapsulated iris diaphragm mechanism with a lubricant, for example grease may be provided. As a result of the encapsulation, the lubricant cannot be washed out. The lubrication is thus substantially maintenance-free. Further, the means for coupling between the actuator and the iris diaphragm mechanism, owing to the direct attachment to the housing of the actuator, may be designed to be short. This contributes to a reduction in an installation space requirement. An additional cover for sealing off the iris diaphragm mechanism can be dispensed with. This contributes to it being possible for the compressor to be produced in a more compact manner.

In summary, the concept described contributes to the resolution of the conflicting aims mentioned at the beginning.

According to one embodiment, the actuator is in the form of a cover for the opening of the housing. In particular, it is not necessary for an additional cover to be provided, since the associated function in this case is integrated into the actuator itself.

According to a further configuration, the actuator, at least in one portion, has a flat bottom side by way of which the actuator is fixed on the housing from the outside so as to cover the opening. This ensures simple assembly and reliable functioning.

According to one embodiment, provision is made of a sealing material which surrounds the opening and which is arranged between the actuator and the housing. The sealing material is for example an 0-ring or some other sealing element. The sealing material is for example a rubber material. In this way, the above-described sealing function is effected.

According to one embodiment, the actuator or the housing has a groove which surrounds the opening and in which the sealing material is arranged. In this way, the sealing material is fixed securely on one of the two components or received therein.

According to one embodiment, the actuator is, via a coupling mechanism arranged within the housing, mechanically coupled to an adjustable adjusting ring of the iris diaphragm mechanism for closing or opening the diaphragm aperture. In this way, the coupling mechanism is likewise completely integrated into the housing and is also sealed off by the actuator. The coupling mechanism is thus not exposed, as a result of which soiling thereof can be avoided or almost avoided. This contributes overall to a long service life of the iris diaphragm mechanism, wherein unimpaired functionality over a long period of time is ensured.

In additional, analogously to above, it is the case that efficient and effective lubrication of the integrated coupling mechanism with lubricants such as grease is made possible. As a result of the encapsulation, washing-out of the lubricant is avoided and maintenance-free lubrication is provided. The coupling mechanism is substantially a mechanism which couples the actuator to the adjusting ring such that this is actuable. The coupling mechanism comprises for example a coupling bar which is attached rotationally conjointly to an actuator shaft of the actuator and which is connected fixedly via a coupling pin to the adjusting ring for the purpose of adjusting the latter.

The housing described may have various embodiments, For example, the housing may be of single-part or multi-part form.

For example, the housing is of two-part form, wherein a first part of the housing is a part of a compressor housing and a second part is in the form of a housing cover connected to the first part. The iris diaphragm mechanism is thus mounted partly on the compressor housing and partly on the housing cover, wherein the housing cover and the compressor housing form a housing unit for the mechanism.

In another embodiment, the housing is formed as part of a compressor housing. In this case, a single-part solution of the compressor housing is involved, which compressor housing is produced for example in a casting process.

In a further embodiment, the housing is a housing which is separate from the compressor housing and which is fixed on the compressor housing. In other words, it is a separate structural unit which has the iris diaphragm mechanism together with the coupling mechanism and the actuator and which is attached as this structural unit to the compressor housing. The separate housing may analogously be of single-part or multi-part form.

Also disclosed is a charging device for an internal combustion engine having a rotor bearing in which a rotor shaft is rotatably mounted, and having a compressor according to one of the previously described embodiments. The charging device is designed as an exhaust-gas turbocharger or as an electromotively operated charger or as a charger operated via a mechanical coupling to the internal combustion engine. Thus, for example, the charging device is designed as an exhaust-gas turbocharger which has an exhaust-gas turbine for driving the compressor impeller of the compressor or, alternatively, is designed as an electromotively operated charger (also referred to as an E booster), which has an electromotive drive for driving the compressor impeller of the compressor.

As an alternative to the abovementioned embodiments, the charging device may furthermore also be designed as a charger operated via a mechanical coupling to the internal combustion engine. Such a coupling between the internal combustion engine and the radial compressor can be accomplished by means of an intermediate transmission, for example, which is operatively connected to a rotating shaft of the internal combustion engine, on the one hand, and to the rotor shaft of the radial compressor, on the other hand.

The above-described compressor is suitable in all embodiments both for an exhaust-gas turbocharger, in which, as mentioned at the beginning, a turbine is driven by an exhaust-gas mass flow, and for an electromotively operated charger. An electromotively operated charger or a charging device having an electromotively operated charger is also referred to as a so-called E booster or E compressor.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 shows a schematic sectional view of a charging device with a compressor with an iris diaphragm mechanism;

FIGS. 2A to 2C show schematic plan views of the iris diaphragm mechanism in three different states;

FIG. 3 shows a schematic cross-sectional view of a compressor with an iris diaphragm mechanism; and

FIG. 4 shows a schematic cross-sectional view of a compressor with an iris diaphragm mechanism as per an exemplary embodiment of the invention.

### DETAILED DESCRIPTION

An exemplary embodiment will be described below with the aid of the appended figures. Identical elements or elements of identical action are provided with the same reference signs throughout the figures.

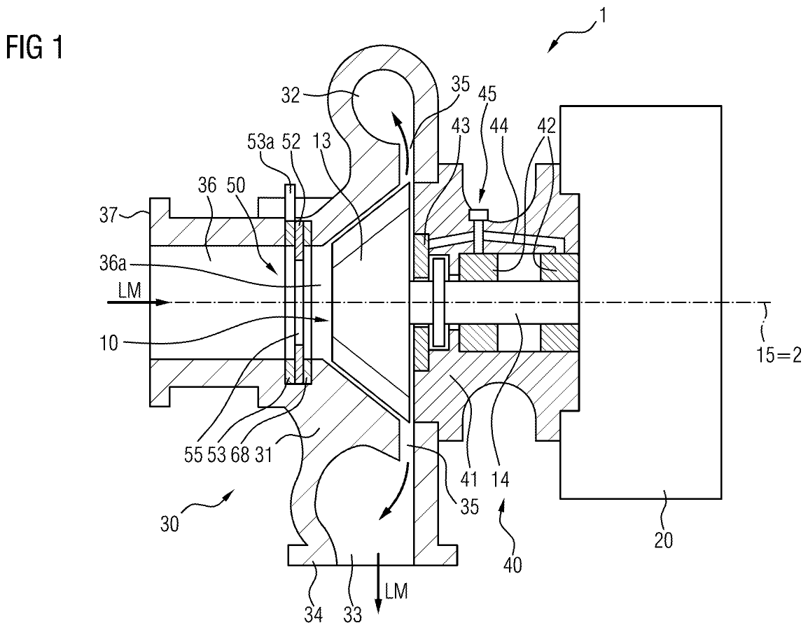

FIG. 1 schematically shows, in a sectional illustration, an example of a charging device 1, which comprises a compressor 30 (a radial compressor in this case), a rotor bearing 40 and a drive unit 20. The compressor 30 has an optional overrun air recirculation valve (not illustrated), and an air mass flow LM is also indicated by arrows. A so-called charger rotor 10 of the charging device 1 has a compressor impeller 13 (also referred to as compressor wheel) and a rotor shaft 14 (also referred to as shaft). The charger rotor 10 rotates about a rotor axis of rotation 15 of the rotor shaft 14 during operation. The rotor axis of rotation 15 and at the same time the charger axis 2 (also referred to as longitudinal axis) are illustrated by the indicated center line and identify the axial orientation of the exhaust-gas charging device 1. Here, the charger rotor 10 is supported in a bearing housing 41 with its rotor shaft 14 by means of two radial bearings 42 and one axial bearing disk 43. Both the radial bearings 42 and the axial bearing disk 43 are supplied with lubricant via oil supply channels 44 of an oil connection 45.

In this example, a charging device 1, as illustrated in FIG. 1, has a multi-part construction. Here, a housing of the drive unit 20, a compressor housing 31 which is able to be arranged in the intake tract of the internal combustion engine, and a rotor bearing 40 which is provided between the housing of the drive unit 20 and the compressor housing 31 are arranged next to one another with respect to the common charger axis 2 and are connected together in terms of assembly, wherein alternative arrangements and configurations of drive units and rotor bearings are also possible.

The charger rotor 10 constitutes a further structural unit of the charging device 1 and has at least the rotor shaft 14 and the compressor impeller 13, which compressor impeller is arranged in the compressor housing 31 and has an impeller blade arrangement 131. The compressor impeller 13 is arranged at one end of the rotor shaft 14 and is connected rotationally conjointly to the latter. The rotor shaft 14 extends in the direction of the charger axis 2 axially through the bearing housing 41 and is provided therein with rotary support in the axial and radial directions about its longitudinal axis, the rotor axis of rotation 15, wherein the rotor axis of rotation 15 lies in the turbocharger axis 2, i.e. coincides therewith.

The compressor housing 31 has an air supply channel 36, which optionally has an intake pipe connector piece 37 for connection to the air intake system (not illustrated) of the internal combustion engine and runs in the direction of the charger axis 2 toward the axial end of the compressor impeller 13. Via this air supply channel 36, the air mass flow LM is drawn in from the air intake system by the compressor impeller 13 and conducted to the compressor impeller 13. The air supply channel 36 may also be part of an intake connector and thus not part of the compressor housing 31. The air supply channel 36 adjoins for example the compressor housing 31 and forms a compressor inlet 36a for the conducting of the air mass flow LM to the compressor impeller 13.

Furthermore, the compressor housing 31 generally has a ring-shaped channel which is arranged in a ring-shaped manner around the charger axis 2 and the compressor impeller 13 and which widens in a spiral-shaped manner away from the compressor impeller 13, and which is referred to as a spiral channel 32. Said spiral channel 32 has a gap opening which runs at least over a part of the inner circumference and which has a defined gap width, the so-called diffuser 35, which, directed in a radial direction away from the outer circumference of the compressor impeller 13, runs into the spiral channel 32 and through which the air mass flow LM flows away from the compressor impeller 13 at elevated pressure into the spiral channel 32.

The spiral channel 32 furthermore has a tangentially outwardly directed air discharge channel 33 with an optional manifold connector piece 34 for connection to an air manifold (not illustrated) of an internal combustion engine. Through the air discharge channel 33, the air mass flow LM is conducted at elevated pressure into the air manifold of the internal combustion engine.

In FIG. 1, the drive unit 20 is not shown in any more detail and may be embodied either as an exhaust-gas turbine or as an electromotive drive unit or else as a means for mechanically coupling to the internal combustion engine, for example as an intermediate transmission which is operatively connected to a rotating shaft of the internal combustion engine, this making the charging device 1 an exhaust-gas turbocharger in the one case and an electromotively operated charger, also referred to as an E booster or E compressor, or a mechanical charger in the other case. In the case of an exhaust-gas turbocharger, provision would be made opposite the compressor impeller 13 for example of a turbine impeller (also referred to as a turbine wheel), which would likewise be arranged for conjoint rotation on the rotor shaft 14 and be driven by an exhaust-gas mass flow.

Upstream of the compressor impeller 13 in the air mass flow LM, an iris diaphragm mechanism 50 is, in addition to or as an alternative to an overrun air recirculation valve (see FIG. 1), arranged in the air supply channel 36 immediately in front of a compressor inlet 36a (also compressor entry), and/or forms at least one sub-region of the air supply channel 36 immediately in front of the compressor inlet 36a of the compressor housing 31. With regard to its functional principle, the iris diaphragm mechanism 50 is similar to an iris diaphragm in a camera. The iris diaphragm mechanism 50 is designed to at least partially close or open a diaphragm aperture such that variable setting of a flow cross section for the air mass flow LM, for flow against the compressor impeller 13, is possible, at least over a sub-region of the flow cross section. The iris diaphragm mechanism 50 allows a characteristic map shift for the compressor 30 in that it acts as a variable inlet throttle for the compressor impeller 13.

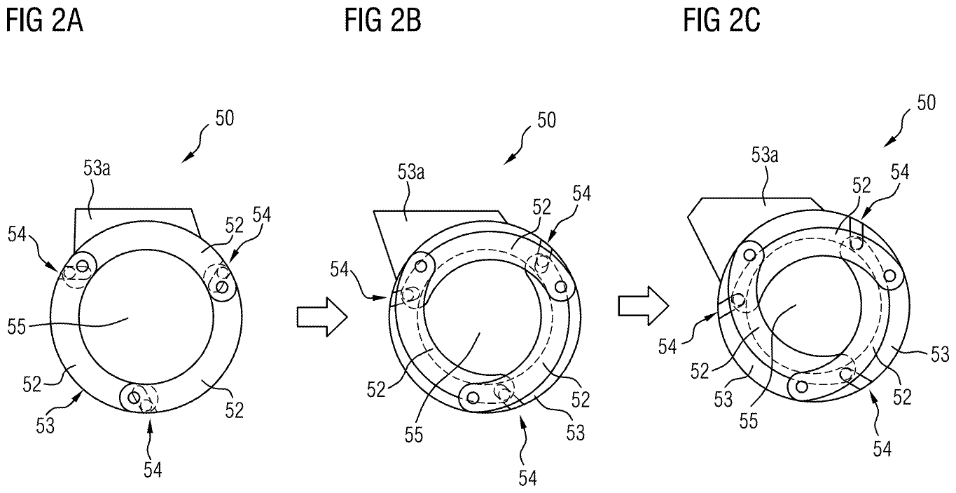

FIGS. 2A to 2C schematically show the iris diaphragm mechanism 50 of the charging device 1 in three different operating states. The iris diaphragm mechanism 50 is fixed on or in the compressor housing 31 and/or at least partially forms the latter. Alternatively, the iris diaphragm mechanism 50 is mounted on a separate, fixed housing for the iris diaphragm mechanism 50. Alternatively, the iris diaphragm mechanism 50 is mounted on or in a multi-part housing, wherein a part of the multi-part housing is formed by the compressor housing 31 and a part is formed by an additional, separate housing (element).

The iris diaphragm mechanism 50 has a bearing ring 68 which is fixed in the air supply channel 36 so as to be concentric with the compressor inlet 36a, an adjusting ring 53 which is arranged so as to be concentric with said bearing ring and is rotatable about a common center and has an adjusting lever 53a, and a plurality of lamellae 52 which are mounted so as to be rotatable about a respective center of rotation in the bearing ring 68. Instead of the bearing ring 68, the compressor housing 31 or another housing (element) may also serve as a bearing. The lamellae 52 have for example a plate-like lamella main body and at least one pin-like actuating element (not visible here), which is designed for actuating the respective lamella 52, as integral contituent parts of the respective lamella 52.

The lamellae 52 are also rotatable and/or displaceable on the adjusting ring 53, for example by means of the actuating element. In the example, the adjusting ring 53 has three grooves (indicated in the figures) for the mounting/guiding of the lamellae 52. The lamellae 52 are synchronized and moved via the adjusting ring 53. The adjusting ring 53 is mounted for example on or in the housing. By actuation of the adjusting ring 53, the lamellae 52 are pivoted radially inward and narrow a diaphragm aperture 55 of the iris diaphragm mechanism 50. Here, FIG. 2A shows the diaphragm aperture 55 with a maximum opening width (open position), FIG. 2B shows the diaphragm aperture 55 with a reduced opening width, and FIG. 2C shows the diaphragm aperture 55 with a minimum opening width (closed position).

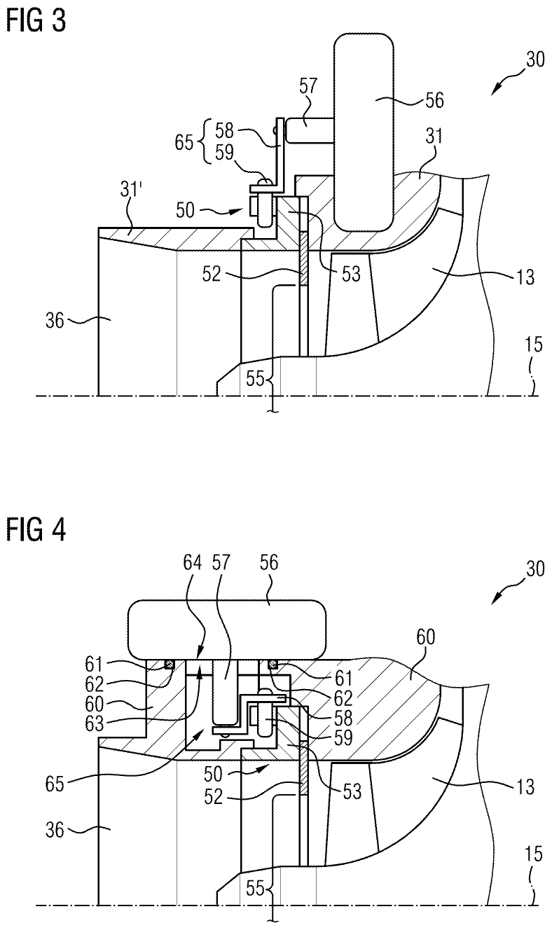

FIG. 3 shows, in a schematic side (transverse) view, a compressor 30 with an iris diaphragm mechanism 50. The iris diaphragm mechanism 50 is illustrated with the adjusting ring 53 and lamellae 52, which delimit the diaphragm aperture 55. The iris diaphragm mechanism 50 is mounted between the compressor housing 31 and a further housing element 31′, which is connected to the compressor housing 31. An actuator 56 having an actuator shaft 57 is mounted on the compressor housing 31. A coupling bar 58 is attached rotationally conjointly to the actuator shaft 57 and is in turn itself connected to the adjusting ring 53, for example to the aforementioned adjusting lever, by way of a coupling pin 59. In this way, by actuation of the actuator 56 and rotation of the actuator shaft 57, it is possible to adjust the adjusting ring 53 and thus, as mentioned at the beginning, the lamellae 52.

In the embodiment described, the actuator 56 is attached to the compressor housing 31, which entails a generally long and elaborate coupling mechanism 65 for actuating the iris diaphragm mechanism 50. The coupling mechanism 65 is formed by the coupling bar 58 and by the coupling pin 59. The coupling mechanism 65 may also comprise further elements which are provided for the coupling of the actuator 56 to the adjusting ring 53 or be of a quite different construction. Furthermore, the coupling mechanism 65 and a part of the adjusting ring 53 are exposed toward the outside. Consequently, these parts can be soiled and, as a result, the mobility of the iris diaphragm mechanism 50 can be impaired. In the worst case, even failure of the function of the iris diaphragm mechanism 50 occurs.

It is pointed out at this juncture that FIG. 3, like FIG. 4 described below, involves illustrations which are not true to scale and are merely schematic. In this regard, for example in FIG. 3, the actuator is illustrated merely as a rounded rectangle, which gives the impression that this is of flat form. In practice, however, the actuators, and in particular the housings thereof, are generally of varied shape.

FIG. 4 shows, in a schematic side view, a compressor 30 as per an exemplary embodiment. Analogously to above, an actuator 56 having an actuator shaft 57 is shown. A coupling bar 58 is in turn attached rotationally conjointly to the actuator shaft 57 and is itself attached to the adjusting ring 53 by means of the coupling pin 59. By contrast to the previous example, the iris diaphragm mechanism 50 and the coupling mechanism 65, consisting of the coupling bar 58 and the coupling pin 59, are arranged within a housing 60 of the compressor 30.

In other words, the aforementioned elements are integrated into the housing 60. The housing 60 is for example the compressor housing 31 (see FIGS. 1 and 3). However, it may also be a separate housing, or a two-part housing consisting of the compressor housing and an additional housing element or cover. The housing 60 at least partially delimits the air supply channel 36. The housing 60 has outwardly toward the surroundings an opening 63 via which the actuator 56 is mechanically coupled to the iris diaphragm mechanism 50 for the purpose of actuating the latter.

In the shown exemplary embodiment as per FIG. 4, the actuator 56 acts as a cover for the housing 60 and closes off the opening 63 in a sealing manner. For this purpose, the housing 60 has, so as to surround the opening 63, a groove 62 in which sealing material 61 is arranged. Alternatively, the groove 62 and the sealing material 62 are arranged in the actuator 56 itself. By contrast to the embodiment as per FIG. 3, in the exemplary embodiment in FIG. 4, the bottom side 64 of the actuator 56 is of flat form and covers the opening 63 completely, with the result that the covering function is achieved.

The actuator 56 itself serves as a seal. At the same time, by contrast to the embodiment as per FIG. 3, the coupling mechanism 65 itself is integrated into the housing 60. It is thus not necessary for moving parts to be sealed off with respect to the surroundings. The flow-guiding components of the compressor 30, in particular the air supply channel 36, are thus sealed off with respect to the surroundings on the compressor side.

It should be pointed out at this juncture that the compressor 30 described does not necessarily have to be part of the charging device 1 described by way of example in FIG. 1. Rather, the charging device 1 may also be configured differently.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

1. A compressor for a charging device of an internal combustion engine comprising:
a compressor impeller arranged for conjoint rotation on a rotor shaft;
an air supply channel for conducting an air mass flow to the compressor impeller;
a housing which at least partially delimits the air supply channel;
an iris diaphragm mechanism located in the housing and upstream of the compressor impeller;
a plurality of lamellae to close and open a diaphragm aperture, such that variable setting of a flow cross section for the air mass flow for flow against the compressor impeller; and
an actuator mechanically coupled to the iris diaphragm mechanism via an opening in the housing, wherein the actuator is arranged on the housing such that the opening is a sealed-off by the actuator.

2. The compressor as claimed in claim 1, wherein the actuator is a cover for the opening of the housing.

3. The compressor as claimed in claim 1, wherein the actuator is fixed on the housing from the outside with a flat bottom side to cover the opening.

4. The compressor as claimed in claim 1, wherein a sealing material lines the opening and is arranged between the actuator and the housing.

5. The compressor as claimed in claim 4, wherein one of the housing and the actuator has a groove which surrounds the opening and in which the sealing material is arranged.

6. The compressor as claimed in claim 1, wherein the actuator is arranged within the housing via a coupling mechanism and mechanically coupled to an adjusting ring of the iris diaphragm mechanism for closing and opening the diaphragm aperture.

7. The compressor as claimed in claim 1, wherein the housing is one of single-part and multi-part form.

8. The compressor as claimed in claim 7, wherein the housing is of two-part form, wherein a first part of the housing is a part of a compressor housing and a second part is a housing cover connected to the first part.

9. The compressor as claimed in claim 1, wherein the housing is formed as part of a compressor housing.

10. The compressor as claimed in claim 1, wherein the housing is a separate part from a compressor housing and is fixed on the compressor housing.

11. A charging device for an internal combustion engine, comprising:
a rotor shaft is rotatably mounted in a rotor bearing;
a compressor having a compressor impeller arranged for conjoint rotation on a rotor shaft, an air supply channel for conducting an air mass flow to the compressor impeller, a housing which at least partially delimits the air supply channel, an iris diaphragm mechanism located in the housing and upstream of the compressor impeller, a plurality of lamellae to close and open a diaphragm aperture, such that variable setting of a flow cross section for the air mass flow for flow against the compressor impeller; and an actuator mechanically coupled to the iris diaphragm mechanism via an opening in the housing, wherein the actuator is arranged on the housing such that the opening is a sealed-off by the actuator; and
wherein the charging device is one of an exhaust-gas turbocharger, an electromotively operated charger, and as a charger operated via a mechanical coupling to the internal combustion engine.
